(19) United States
(12) Patent Application Publication
(10) Pub. No.: US 2009/0190096 A1
(43) Pub. Date: Jul. 30, 2009

(54) AUTOSTEREOSCOPIC DISPLAY

(75) Inventors: Cheng-Huan Chen, Taoyuan County (TW); Chao-Hsu Tsai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/269,869

(22) Filed: Nov. 12, 2008

(30) Foreign Application Priority Data
Jan. 28, 2008 (TW) 97103087

(51) Int. Cl. G02B 27/22

(52) U.S. Cl. 353/7; 359/463

(57) ABSTRACT

An autostereoscopic display includes a plurality of micro-projection modules, wherein each of the micro-projection modules projects a sectional image of a 3-D image formed by combining a plurality of images in different viewing-angles. The autostereoscopic display further includes a viewing zone modulating screen having a plurality of image regions for respectively receiving the corresponding sectional images to form a plurality of images corresponding to different viewing-angles, wherein two images belonging to different viewing-angles establish a stereo display image.

### CROSS-REFERENCE TO RELATED APPLICATION

This application claims the priority benefit of Taiwan application serial no. 97103087, filed on Jan. 28, 2008. The entirety of the above-mentioned patent application is hereby incorporated by reference herein and made a part of specification.

### BACKGROUND OF THE INVENTION

1. Field of the Invention

The present invention relates to an autostereoscopic display with integrated projection array.

2. Description of Related Art

According to the visualization characteristic of human naked eyes, when the left eye and the right eye of a viewer respectively look at two images of the same object or scene but with different parallaxes from each other, a stereo image is sensed by the viewer, which is just the basic principle of stereo display. The stereo presentation in the earlier days is produced by taking advantage of the polarized light effect, i.e. to output two images in different polarization directions and let a viewer wearing a pair of polarized glasses so as the left and right eyes to respectively receive the images with corresponding parallax.

After then, autostereoscopic display technologies on which viewers don't need to wear any extra eye-ware to watch stereo images are developed based on the technology of digital display. In terms of projection-type display technology, a plurality of projectors is used to respectively project an image corresponding to an assigned viewing zone. FIG. 1 is a diagram illustrating a conventional projection-type autostereoscopic display technology. Referring to FIG. 1, a plurality of image projectors 50 respectively projects an image corresponding to a viewing zone. Then, the projected images respectively strike the left-right eyes of a viewer 56 by means of a field lens 52 to construct a stereo image, wherein a light diffusion plate 54 is employed to lighten unevenness on the screen.

In the projection system of the 3-D display, the field lens 52 is usually formed by one or several Fresnel lenses to achieve an autostereoscopic display with multiple viewing zones function in association of the image projectors 50. The number of the image projector 50 is equal to the number of the viewing zones, and the viewable resolution of each the viewing zone is the resolution of the projector.

A sufficient projection distance is required for each projector to project an image onto the whole screen in such a system. In fact, the larger the screen size, the longer the required distance is and the larger the system volume is. When tens or hundreds of viewing zones are required, it is very possible that the internal space of the system is not enough to accommodate the projectors of the corresponding sufficient number. Since a field lens 54 possesses a certain focal length; and the longer the required focal length (depending on the projection distance), the larger the dimension of the field lens is, therefore, the system must be voluminous. In particular, the larger the screen, the system volume grows rapidly.

### SUMMARY OF THE INVENTION

Accordingly, the present invention is directed to an autostereoscopic display, which is able to keep a smaller volume and maintain the good stereo display effect for an increasing screen size and an increasing number of viewing zones.

The present invention provides an integrated-projection-array autostereoscopic display, which includes a plurality of micro-projection modules and a viewing zone modulating screen. The autostereoscopic display includes multiple micro-projection modules formed in an array. Each of the micro-projection modules projects a sectional image including multiple images at different viewing zones. A viewing-zone modulating screen has multiple image regions, respectively receiving the sectional images to form multiple images corresponding to the viewing zones. Two different images form a stereo-display image.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a conventional projection-type autostereoscopic display technology.

FIG. 2 is a 3-D structure diagram of an integrated-projection-array autostereoscopic display where the distribution images are tightly joined according to an embodiment of the present invention.

FIG. 3 is a 3-D structure diagram of an integrated-projection-array autostereoscopic display where the distribution images are partially-overlapping joined according to an embodiment of the present invention.

FIG. 4 is a top view diagram of an autostereoscopic display taking the 2×2 array of FIG. 2 as an example.

FIG. 5 is a side view diagram of an autostereoscopic display taking the 2×2 array of FIG. 2 as an example.

FIG. 6 is a structure diagram of a viewing zone modulating screen according to an embodiment of the present invention.

FIG. 7 is a diagram showing how images for different viewing zones are produced by using the viewing zone modulating screen 110a of FIG. 6.

FIG. 8 is a structure diagram of a viewing zone modulating screen according to another embodiment of the present invention.

FIG. 9 is a diagram showing how images for different viewing zones are produced by using the viewing zone modulating screen 110b of FIG. 8.

FIG. 10 is a diagram showing the relative placing angle between a viewing zone modulating screen and micro-projection modules.

FIG. 11 is a distribution diagram of the pixels and their corresponding viewing zones on a sectional image according to an embodiment of the present invention.

FIG. 12 is a diagram showing the placing angle of a lens array of a viewing zone modulating screen according to an embodiment of the present invention.

FIG. 13 is a diagram showing the relative placing angle of a parallax barrier layer of a viewing zone modulating screen according to an embodiment of the present invention.

FIG. 14 is a diagram showing the relative placing angle between a viewing zone modulating screen and micro-projection modules.

FIG. 15 is a distribution diagram of the pixels and their corresponding viewing zones on a sectional image according to an embodiment of the present invention.

FIG. 16 is a distribution diagram of the pixels and their corresponding viewing zones on a sectional image according to an embodiment of the present invention.

FIG. 17 is a distribution diagram of the pixels and their corresponding viewing zones on a sectional image according to an embodiment of the present invention.

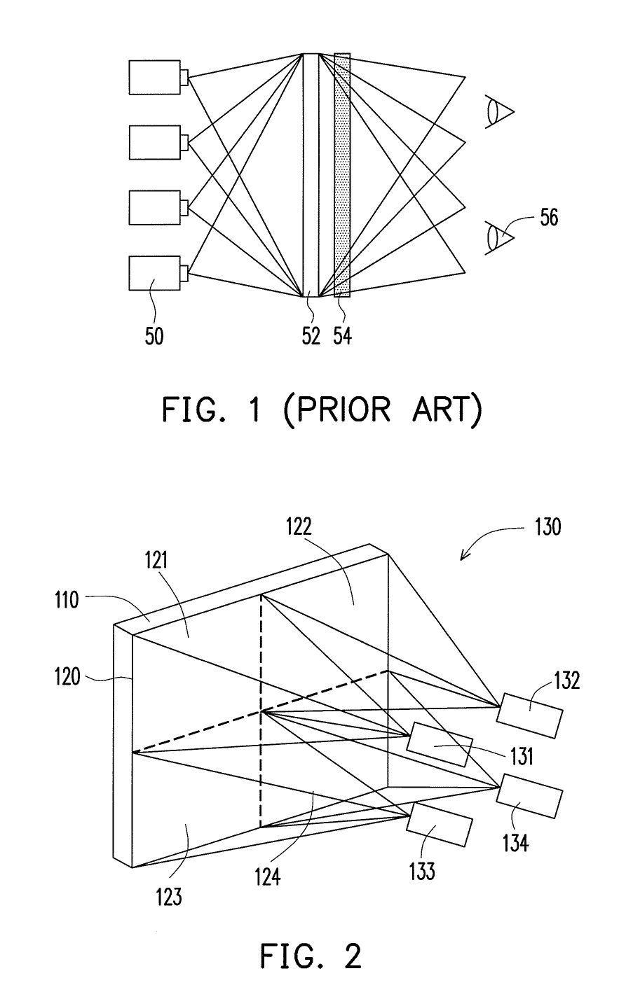

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In the provided embodiments, the stereo display effect is achieved by using projection module array. Each of the micro-projection modules projects a sectional image having multiple images at different viewing angles. The viewing zone modulating screen can be, for example, a lenticular array or a parallax barrier plate for achieving the desired 3-D display effect; however, the present invention is not limited to the above-mentioned two designs. A plurality of projection modules respectively projects a sectional image of a 3-D image formed by combining a plurality of images in different viewing-angles, so that a 3-D image with a desired size and resolution can be realized by joining the projected sectional images.

FIG. 2 is a 3-D structure diagram of an autostereoscopic display. Referring to FIG. 2, an autostereoscopic display system includes, for example, an array 130 composed of a plurality of projection modules 131-134 and a viewing zone modulating screen 110 having the function of directing pixel images to corresponding viewing zones. The number of the projection modules can be four as the example to form a 2×2 array. However, the present invention does not limit the manner of forming the array of the projection modules, the number of the modules and the size of each module; for example, the array can also be an one-dimensional array.

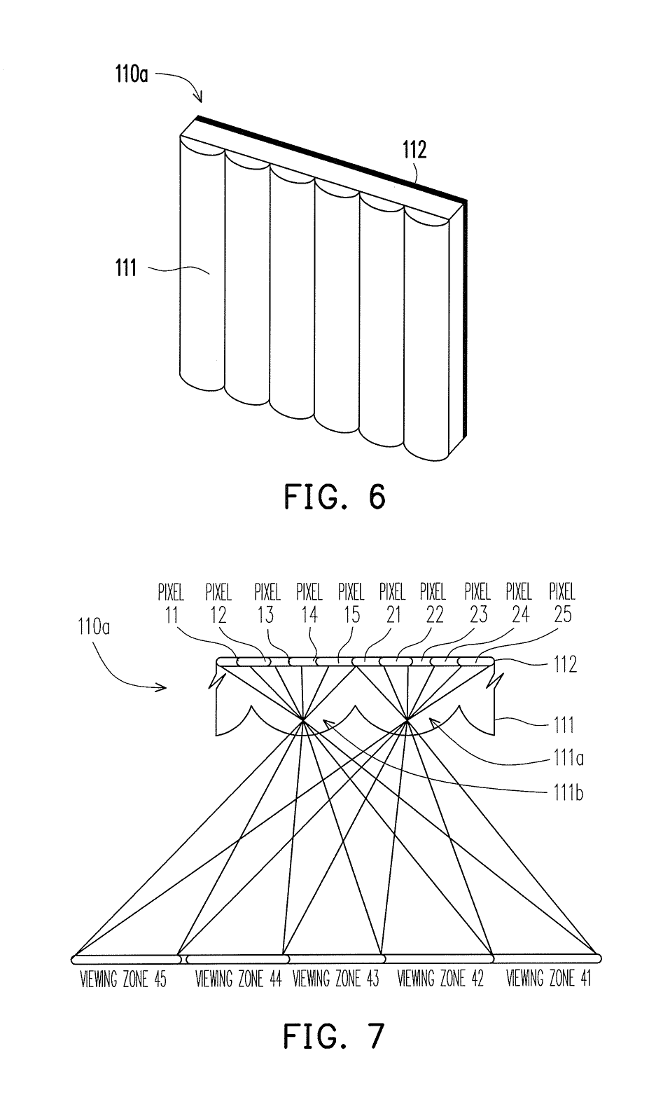

The projection module array 130 of the present invention is for combining the images of the projection modules 131-134 to construct a complete image. The viewing zone modulating screen of the autostereoscopic display is for guiding each pixel of the images to a corresponding viewing zone so as to establish a 3-D display image with a plurality of viewing zones and having a high resolution for each the viewing zone. Each of the projection modules 131-134 of the projection module array 130 is respectively in charge of displaying each of the sectional images 121-124 on a region of the complete image so as to form the imaging on a partial region of the viewing zone modulating screen 110. The projected images produced by all the projection modules 131-134 of the projection module array 130 are jointed into a complete image 120 on the viewing zone modulating screen 110, wherein the complete image 120 contains the images of different viewing angles corresponding to different viewing zones. The viewing zone modulating screen 110 then guides each pixel image to a corresponding viewing zone position in front of the screen (FIGS. 6 and 7), so that a viewer can see the images with different viewing-angles through the left-right eyes and see the 3-D image with a stereo effect.

When the viewer moves, since there are still other viewing zones at the side of the viewer corresponding to different view angle, thus, the viewer is able to see not only a 3-D image, but also other 3-D images with different viewing-angles depending on the viewing zone where the viewer is located. This manner has the motion parallax function.

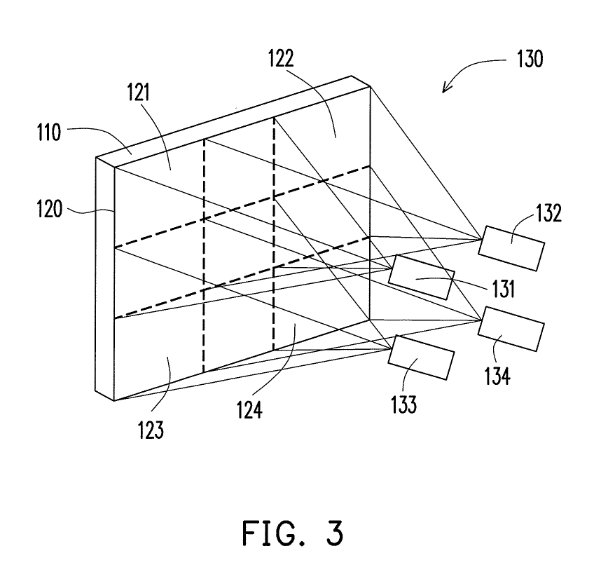

The sectional images 121-124 of all the projection modules can be tightly joined as shown in FIG. 2 or partially overlapping joined as shown in FIG. 3, wherein the partially overlapping joining way can eliminate the seam trace between two adjacent sectional images.

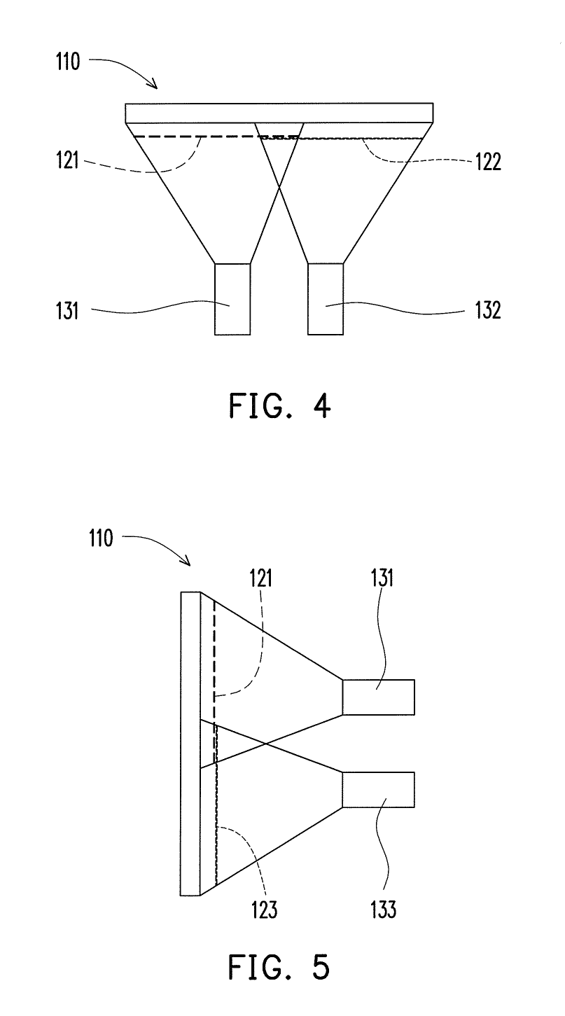

FIG. 4 is a top view diagram of an autostereoscopic display taking the 2×2 array of FIG. 2 as an example. Referring to FIG. 4, two sectional images 121 and 122 produced by the projection modules 131 and 132 are, for example, partially overlapped on the viewing zone modulating screen 110. FIG. 5 is a side view diagram of an autostereoscopic display taking the 2×2 array of FIG. 2 as an example. Referring to FIG. 5, similarly to FIG. 4, two sectional images 121 and 123 produced by the projection modules 131 and 133 are, for example, partially overlapped on the viewing zone modulating screen 110 as well.

FIG. 6 is a structure diagram of a viewing zone modulating screen according to an embodiment of the present invention Referring to FIG. 6, a viewing zone modulating screen 110a is formed by, for example, a viewing zone modulating layer 111 and an imaging layer 112 (for example, a light diffusing layer 112). The viewing zone modulating layer 111 is, for example, a lenticular array 111 which has a plurality of micro cylinder structures on a side thereof and the cylinder structures are arranged, for example, in parallel. In the embodiment, the cylinder surfaces are extended in, for example, the vertical direction. The light diffusing layer 112 is disposed on a flat surface opposite to the side of the cylinder structures and faces the projection modules.

The imaging principle is depicted in the following. FIG. 7 is a diagram showing how images for different viewing zones are produced by using the viewing zone modulating screen 110a of FIG. 6. Referring to FIG. 7, the images projected by the projection modules 131-134 are images on the light diffusing layer 112 behind the lenticular array 111. The number of horizontal pixels corresponding to a lenticular element 111a or 111b is just the number of viewing zones. The embodiment of FIG. 7 has, for example but not limited to by the present invention, five viewing zones. Among the pixel images on a complete image combined by a plurality of sectional images, every five longitudinal pixel images columns are counted as a set, and each set of the pixel images is corresponding to a lenticular element, wherein the five pixel images columns 11-15 of the first set are respectively projected onto different viewing zones 41-45 through, for example, the lenticular element 111b, and the five pixel images columns 21-25 of the second set are respectively projected onto different viewing zones 41-45 as well through, for example, the lenticular element 111a. The pixel images of each set on the image are corresponding to a lenticular element and are respectively projected onto the different viewing zones 41-45 through a lenticular element. An eye located at a viewing zone would see an image of a viewing-angle corresponding to the viewing zone. When the left-right eyes of a viewer are located at two different viewing zones, a stereo image effect is established.

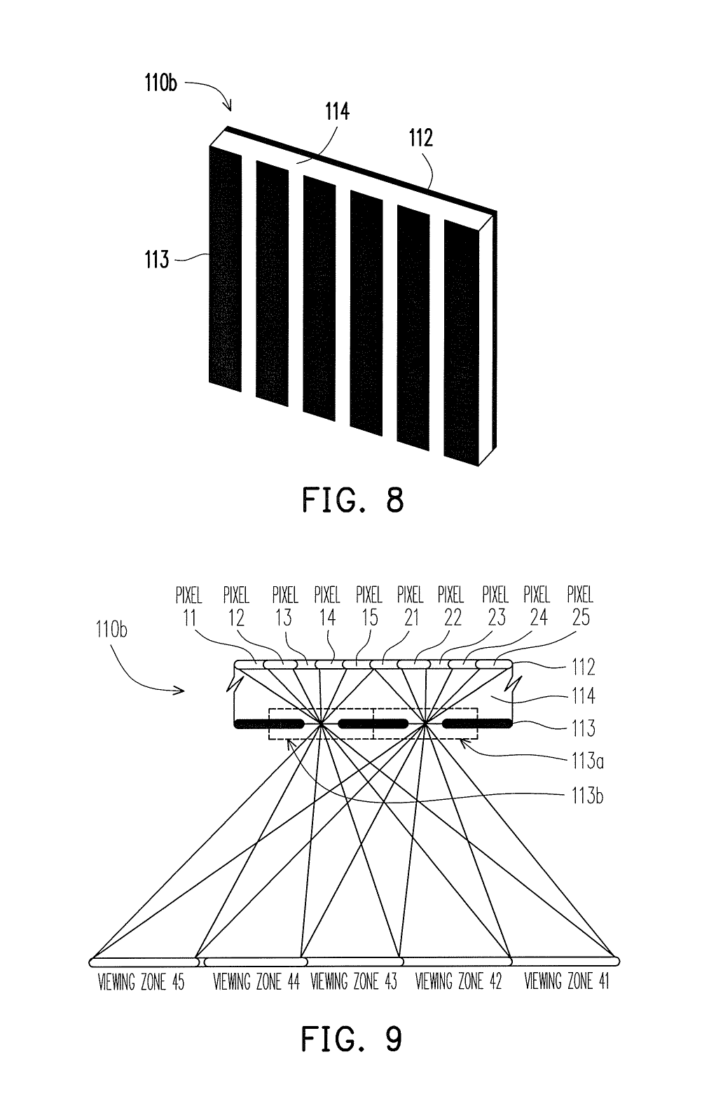

In terms of respectively producing different images for different viewing zones, the design of FIG. 6 is not an exclusive design. FIG. 8 is a structure diagram of a viewing zone modulating screen according to another embodiment of the present invention. Referring to FIG. 8, the viewing zone modulating layer of a viewing zone modulating screen 110b includes, for example, a transparent layer 114 and a parallax barrier layer 113. A plurality of opaque stripe-like regions is disposed on the transparent layer 114 so as to form a grating structure arranged in parallel with an interval between two adjacent grating stripes. An imaging layer 112 is disposed on another side of the transparent layer 114, and the imaging layer 112 is, for example, a light diffusing layer 112. The transparent layer 114 can be composed of air or any transparent material.

FIG. 9 is a diagram showing how images for different viewing zones are produced by using the viewing zone modulating screen 110b of FIG. 8. Referring to FIG. 9, the images projected by the projection modules 131-134 are images on the light diffusing layer 112 behind the transparent layer 114. The number of horizontal pixels corresponding to a parallax barrier element 113a or 113b is just the number of viewing zones. The embodiment of FIG. 9 has, for example but not limited to by the present invention, five viewing zones. Among the pixel images on a complete image combined by a plurality of sectional images, every five longitudinal pixel images columns are counted as a set, and each set of the pixel images is corresponding to a parallax barrier element, wherein the five pixel images columns 11-15 of the first set are respectively projected onto different viewing zones 41-45 through, for example, the parallax barrier element 113b, and the five pixel images columns 21-25 of the second set are respectively projected onto different viewing zones 41-45 as well as through, for example, the parallax barrier element 113a. The pixel images of each set on the image are corresponding to a parallax barrier element and are respectively projected onto the different viewing zones 41-45 through a parallax barrier element. An eye located at a viewing zone would see an image of a viewing-angle corresponding to the viewing zone. When the left-right eyes of a viewer are located at two different viewing zones, a stereo image effect is established.

The above-described two types of viewing zone modulating screens are intended to guide the pixel images in the horizontal direction to different viewing zones. This method may induce resolution unbalance between horizontal and vertical directions, for example, at each viewing zone, a viewer may see an image with a higher vertical resolution and a lower horizontal resolution. Multiple schemes in the following are taken to improve the evenness of the vertical and horizontal resolutions.

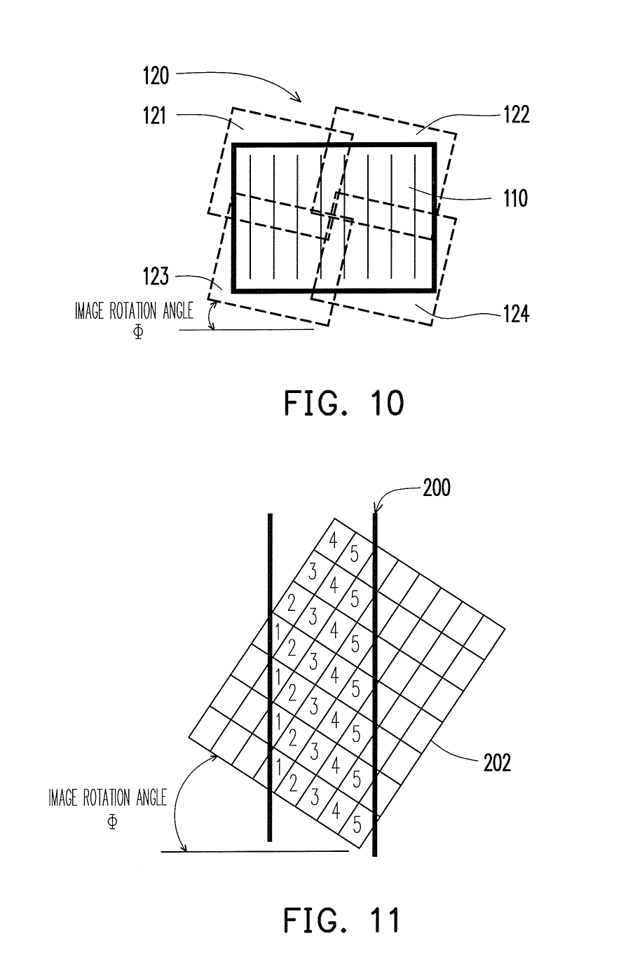

FIG. 10 is a diagram showing the relative placing angle between a viewing zone modulating screen and projection modules. Referring to FIG. 10, taking the configuration of FIG. 2 as an example, a viewing zone modulating screen 110 possesses a horizontal reference direction and a vertical reference direction. A complete image 120 is composed of sectional images 121-124, wherein the sectional images 121-124 are oriented relatively to the horizontal reference direction in an image rotation angle Φ and the rotation angle (D in the embodiment is greater than zero. In addition, the strip direction on the viewing zone modulating screen 110, i.e. the extension direction of the cylinder lenses or the opaque barrier stripes are the same as the vertical reference direction, so that the sectional images have a rotation angle Φ relatively to the viewing zone modulating screen 110.

FIG. 11 is a distribution diagram of the pixel images and the viewing zones on a sectional image according to an embodiment of the present invention. Referring to FIG. 11, one of the sectional images 121-124 shown in FIG. 10 is taken for the depiction. The stripes 200 of the viewing zone modulating screen 110 are in the vertical direction and the pixel images array 202 on the sectional image is oriented in a rotation angle ( ) relatively to the horizontal reference direction. The pixel images array 202 on the sectional image is the images for five viewing zones, for example, the regions 1-5; therefore, there are five viewing zones between two the adjacent stripes 200.

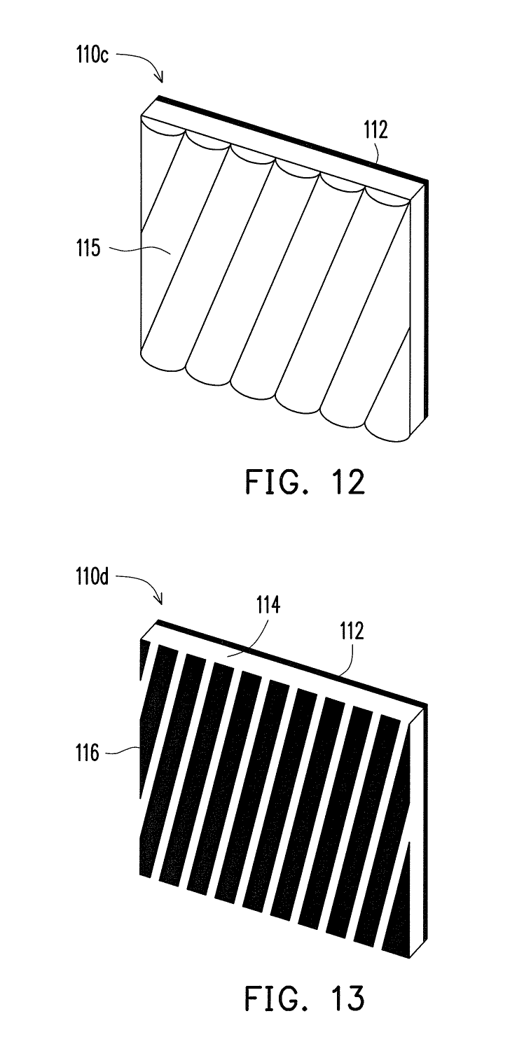

FIG. 12 is a diagram showing the placing angle of a lens array of a viewing zone modulating screen according to an embodiment of the present invention. Referring to FIG. 12, the viewing zone modulating screen 110c in FIG. 12 is similar to the viewing zone modulating screen 110a in FIG. 6 except that the lenticular array 115 in FIG. 12 is oriented not in the vertical direction, but in a bevel angle relatively to the vertical reference direction and the bevel angle is termed as screen tilting angle or screen bevel angle. FIG. 13 is a diagram showing the relative placing angle of a parallax barrier layer of a viewing zone modulating screen according to an embodiment of the present invention. Referring to FIG. 13, the viewing zone modulating screen 110d in FIG. 13 is similar to the viewing zone modulating screen 110b in FIG. 8 except that the parallax barrier layer 116 in FIG. 13 is oriented not in the vertical direction, but in a screen tilting angle.

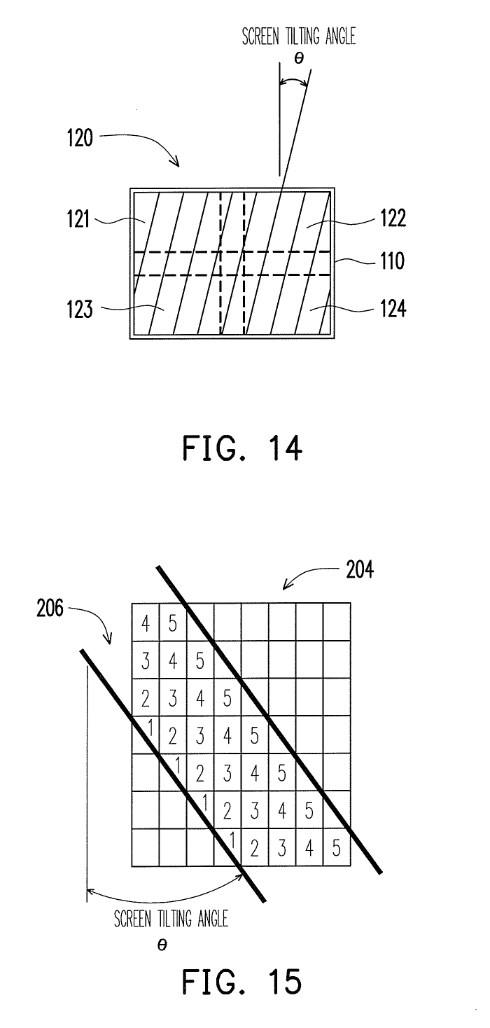

FIG. 14 is a diagram showing the relative placing angle between a viewing zone modulating screen and projection modules. Referring to FIG. 14, the viewing zone modulating screen herein is that of FIG. 12 or FIG. 13, thus, the sectional images 121-124, for example, do not need a rotation, i.e., the rotation angle Φ herein is zero, but the screen tilting angle θ relatively to the vertical reference direction is equal to a non-zero preset value.

FIG. 15 is a distribution diagram of the pixel images and the viewing zones on a sectional image according to an embodiment of the present invention. Referring to FIG. 15, one of the sectional images 121-124 shown in FIG. 14 is taken for the depiction. The stripes 206 of the viewing zone modulating screen 110 are oriented in a non-zero screen tilting angle θ relatively to the vertical reference direction and the pixel images array 204 on the sectional image is oriented in a rotation angle Φ of zero relatively to the horizontal reference direction, i.e. there is no rotation at all. The pixel images array 204 on the sectional image is the images for five viewing zones, for example, the regions 1-5; therefore, there are five viewing zones between two the adjacent stripes 206.

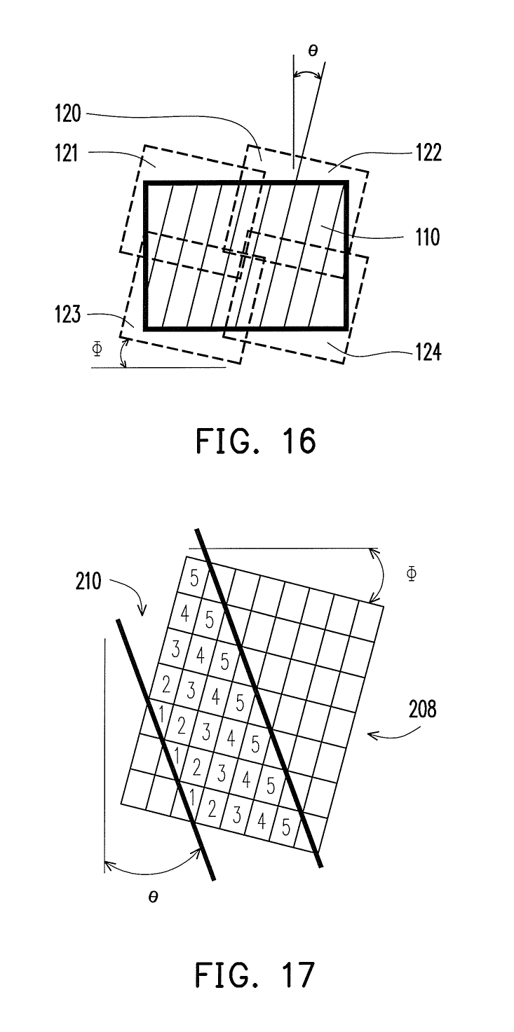

FIG. 16 is a distribution diagram of the pixel images and the viewing zones on a sectional image according to an embodiment of the present invention. Referring to FIG. 16, the configuration herein is that both of the stripes 206 of the viewing zone modulating screen 110 and the sectional images 121-124 have rotations. That is to say, both of the rotation angle Φ and the screen tilting angle θ are not zero. FIG. 17 is a distribution diagram of the pixel images and the viewing zones on a sectional image according to an embodiment of the present invention. Referring to FIG. 17, the configuration herein is that of FIG. 16, i.e., the stripes 210 of the viewing zone modulating screen has a non-zero screen tilting angle θ relatively to the vertical reference direction. The pixel images array 206 on the sectional image has a non-zero rotation angle Φ relatively to the horizontal reference direction, i.e. has a rotation. The pixel images array 208 on the sectional image is the images for five viewing zones, for example, the regions 1-5; therefore, there are five viewing zones between two in the adjacent stripes 210.

It can be seen from the above described, the configurations according to the different embodiments can be that both of the rotation angle Φ and the screen tilting angle θ are zero, or one of the rotation angle Φ and the screen tilting angle θ is zero but the another one is not zero, or both of the rotation angle Φ and the screen tilting angle θ are not zero.

As to the viewing zone modulating layer of the viewing zone modulating screen can be a cylinder lenses array, or a grating structure with a parallax barrier effect, or other optical components with a stereo display effect, which the present invention is not limited to.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An autostereoscopic display, comprising:
a plurality of projection modules, wherein each of the projection modules projects a sectional image including a plurality of images at different viewing-angles; and
a viewing zone modulating screen, having a plurality of image regions for respectively receiving the corresponding sectional images to form a plurality of images corresponding to the different viewing-angles, wherein two different images belonging to different viewing zones establish a stereo display image,
wherein the viewing zone modulating screen possesses a horizontal reference direction and a vertical reference direction, and the sectional images have an image rotation angle relatively to the horizontal reference direction.

2. The autostereoscopic display according to claim 1, wherein the two adjacent ones of the sectional images are tightly joined or partially overlapped each other.

3. The autostereoscopic display according to claim 1, wherein the viewing zone modulating screen comprises a light diffusing layer and a viewing zone modulating layer, wherein the viewing zone modulating layer is for respectively projecting the images corresponding to the viewing zones in different preset directions.

4. The autostereoscopic display according to claim 1, wherein the viewing zone modulating screen comprises a viewing zone modulating layer, wherein the viewing zone modulating layer comprises a plurality of cylinder lenses disposed on the viewing zone modulating layer, the cylinder lenses are arranges in parallel to form a lenses array and the cylinder lenses have a screen tilting angle relatively to the vertical reference direction.

5. The autostereoscopic display according to claim 4, wherein both the image rotation angle and the screen tilting angle are zero.

6. The autostereoscopic display according to claim 4, wherein one of the image rotation angle and the screen tilting angle is zero and another one is non-zero.

7. The autostereoscopic display according to claim 4, wherein both of the image rotation angle and the screen tilting angle are non-zero.

8. The autostereoscopic display according to claim 4, wherein the viewing zone modulating screen further comprises a light diffusing layer disposed on a flat surface of the cylinder lenses and the light diffusing layer faces the projection modules.

9. The autostereoscopic display according to claim 4, wherein each of the projection modules comprises a pixel images array corresponding to the viewing zones and the cylinder-lenses screen with preset tilting angle to produce the desired sectional image.

10. The autostereoscopic display according to claim 1, wherein the viewing zone modulating screen comprises a viewing zone modulating layer, wherein the viewing zone modulating layer comprises:
a transparent layer; and
a parallax barrier layer, located on the transparent layer to form a plurality of stripe-like regions arranged in parallel with an interval between two adjacent stripes, and the stripes have a screen tilting angle relatively to the vertical reference direction.

11. The autostereoscopic display according to claim 10, wherein both of the image rotation angle and the screen tilting angle are zero.

12. The autostereoscopic display according to claim 10, wherein one of the image rotation angle and the screen tilting angle is zero and another one is non-zero.

13. The autostereoscopic display according to claim 10, wherein both of the image rotation angle and the screen tilting angle are non-zero.

14. The autostereoscopic display according to claim 10, wherein the viewing zone modulating screen further comprises a light diffusing layer disposed on the opposite side to the parallax barrier layer on the transparent layer and the light diffusing layer faces the projection modules.

15. The autostereoscopic display according to claim 10, wherein each of the projection modules comprises a pixel images array corresponding to the viewing zones and the parallax-barrier screen with preset tilting angle to produce the desired sectional image.

16. The autostereoscopic display according to claim 1, wherein the array composed of the projection modules comprises an one-dimensional array or a two-dimensional array.
